(19) United States
(12) Patent Application Publication
(10) Pub. No.: US 2005/0047030 A1
(43) Pub. Date: Mar. 3, 2005

(54) Apparatus and method for a power center

(75) Inventor: Noel Lee, Las Vegas, NV (US)

Correspondence Address: LaRiviere, Grubman & Payne, LLP, P.O. Box 3140, Monterey, CA, 93942, US

(73) Assignee: Monster, LLC, Las Vegas, NV (US)

(21) Appl. No.: 10/655,492

(22) Filed: Sep. 3, 2003

(51) Int. Cl. H02H 3/00; H02H 7/00

(52) U.S. Cl. 361/1

(57) ABSTRACT

An apparatus and a method for a power center for electronic components. The power center comprises a power conditioning unit and a power display console. The power conditioning unit may include a first body having a first connecting means and a power display console may include a second body having a second connecting means. The first connecting means may be adapted to mechanically cooperate with second connecting means thereby permitting the unit and the console to be removably attached and de-attached. As such, the console may be positioned to facilitate viewing by a user, and the conditioning unit may be positioned for convenient electrical connection for electronic components.

### FIELD OF THE INVENTION

The present invention is related to a power center. More particularly, the present invention is a power center that includes a power conditioning unit and a power display console, which power display console may be distal from the power conditioning unit.

### BACKGROUND OF THE INVENTION

Power centers act as a power surge protection device between an electrical power supply and sensitive electronic components. Power centers provide protection of sensitive electronic components from voltage and current spikes, and random transient sources. Present power centers may contain a power conditioning unit. A power conditioning unit is comprised of active or passive electronic circuit elements such as varactor diodes that limit voltage levels or relay switches that shunt power spikes and/or disconnect the power from an electronic component. Optionally, power conditioning units may contain an integrated power display. The integrated power display may be a light that indicates the status of the power conditioning unit such as normal or that an over-voltage or over-current event has occurred. A power center is typically connected to an electrical outlet and behind an electronic component. This positioning of a power center is problematic because a user could not easily observe the power conditioning unit voltage and/or current level displayed behind an electronic component. Consequently, there is a need for a power center that has a display visible to a user remotely seated from the power center as well as a power center to provide other additional advantages over presently available power centers.

### BRIEF SUMMARY OF THE INVENTION

Accordingly, the present invention provides a power center for electronic components. The power center comprises a power conditioning unit and a power display console. The power display console is adapted to electrically cooperate while being distal with said power conditioning unit. The power conditioner unit may further include a first body having a first connecting means. The power display console may further include a second body having a second connecting means. The first connecting means is adapted to mechanically cooperate with the second connecting means thereby permitting the unit and the console to be removably attached and de-attached. De-attachment of the unit and the console permits the power conditioning unit to be positioned behind the electronic component and the power display console is positioned in view of a user for ease of monitoring the power center condition. Thus, the console may be positioned to facilitate viewing by a user, and the conditioning unit may be positioned for convenient electrical connection to components.

In one embodiment of the present invention, the power conditioning unit first connecting means is at least one first attaching feature that removably attaches with the power display console second connecting means which is at least one first receiving feature. The at least one first attaching feature is selected from a group consisting of a stud, a hook, a screw, a bolt, a cable, a fastener, and a Velcro® strap. The at least one first receiving feature is selected from a group consisting of a slot, a hole, and an opening.

In another embodiment of the present invention, the power conditioning unit first connecting means has at least one second receiving feature that removably attaches with the power display console second connecting means which is at least one second attaching feature. The at least one second receiving feature is selected from a group consisting of a slot, a hole, and an opening. The at least one second attaching feature is selected from a group consisting of a stud, a hook, a screw, a bolt, a cable, a fastener, and a Velcro® strap.

It is a further feature of the present invention that the power conditioning unit first body further includes a first mounting means for removably attaching the power conditioning unit to a surface selected from a group consisting of a horizontal surface, a vertical surface, or an inclined surface. In addition, the power display console second body further includes a second mounting means for removably attaching the power display console to a surface selected from a group consisting of a horizontal surface, a vertical surface, or an inclined surface. Additionally, another aspect of the present invention is that the first body further comprises an first electrical port and the second body further comprises a second electrical port where said first electrical port and said second electrical port are electrically connected together with a electrically conductive wire. Optionally, the power conditioning unit and the power display console will exchange information, such as status or display data, by a wireless link.

It is an additional feature of the present invention that the power conditioning unit may additionally comprise a wireless link to exchange and update information between said power display console and a remote control unit, wherein said wireless link to exchange and update information is selected from a group consisting of: infrared (IR), radio frequency (RF), and optical. Further aspect of the present invention is a remote control unit suitable for controlling at least one selected from a group consisting of said power conditioning unit and said power display console.

### BRIEF DESCRIPTION OF THE DRAWINGS

For a better understanding of the present invention, reference is made to the below-referenced accompanying drawings. Reference numbers refer to the same or equivalent parts of the present invention throughout the several figures of the drawings.

FIG. 1 is a perspective view of the power center according to a first embodiment of the present invention.

FIG. 1A is a cross-sectional view taken along the line 1A-1A of the power center according to the first embodiment of the present invention, showing a first connecting means of the power conditioning unit.

FIG. 1B is a cross-sectional view taken along the line 1B-1B of the power center according to the first embodiment of the present invention, showing a second connecting means of the power display console.

FIG. 1C is a perspective view of the power center according to the first embodiment of the present invention showing the mechanical cooperation of the first connecting means of the power conditioning unit and a second connecting means of the power display console.

FIG. 1D is a cross-sectional view taken along the line 1A-1A of the power center according to a second embodiment of the present invention showing a first electrical port, a second electrical port, a cavity, and electrical connection of the first and the second electrical ports.

FIG. 2 is a front view of the power center according to a third embodiment of the present invention showing the first mounting means for attaching the power conditioning unit to another surface.

FIG. 3 is a back view of the power center according to a fourth embodiment of the present invention showing the second mounting means for attaching the power display console to another surface.

FIG. 4 is a front view of the power center according to a fifth embodiment of the present invention, showing a wireless remote for controlling the power conditioning unit and the power display console.

### DETAILED DESCRIPTION OF THE INVENTION

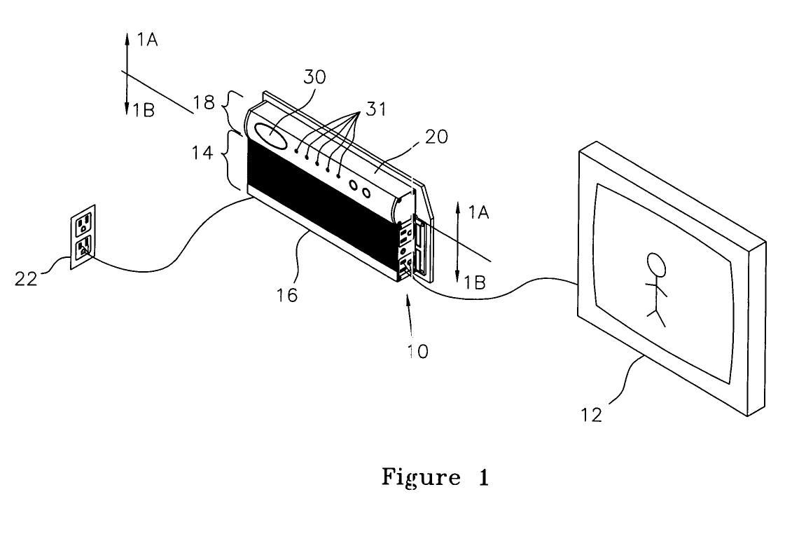

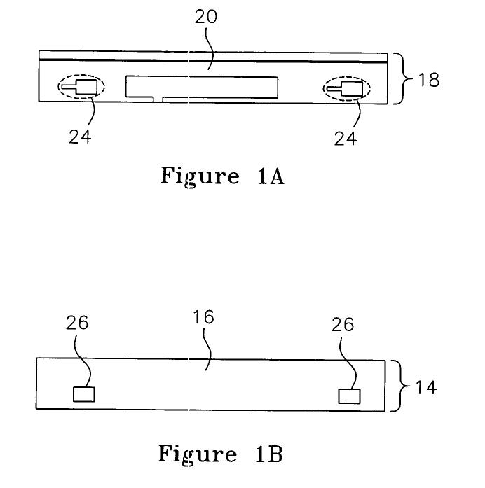

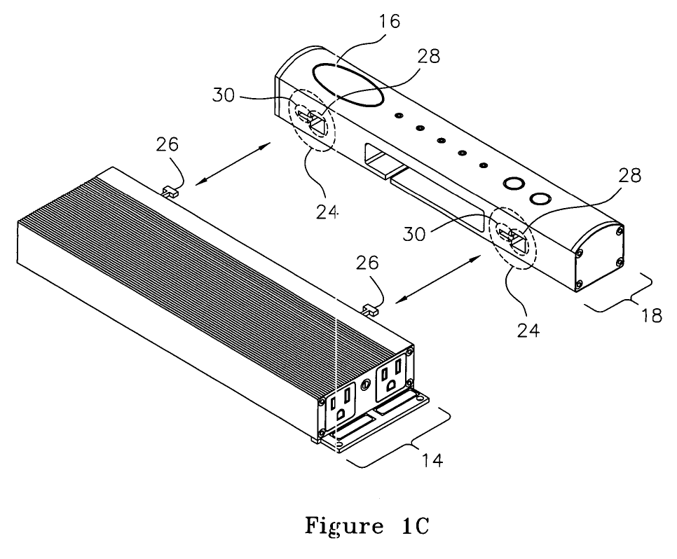

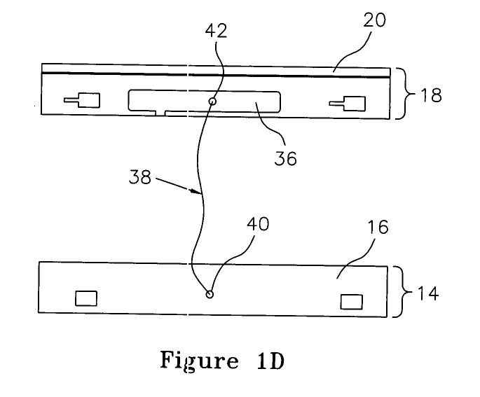

Referring particularly to FIG. 1, a perspective view of the power center according to a first embodiment of the present invention is shown. The power center 10 is a power surge protection device for an electronic component 12. The electronic component 12 may be a stereo, radio, computer, a plasma screen television or the like. The power center 10 comprises a power conditioning unit 14 including a first body 16 and a power display console 18 including a second body 20. The power conditioning unit 14 functions as a filter for a connected electrical power source 22 before the power reaches the electronic component 12. The power conditioning unit 14 may include passive and/or active circuitry components that are arranged in a shunt and or series arrangement to prevent a voltage spike or current spike originating from an electronic power source 22 from reaching the electronic component 12. The passive circuitry components may include resistors, capacitors, inductors, varactor diodes, passive switches, or other electronic filtering components (not shown in diagram). The active circuitry components may include transistors or active switches (not shown in diagram).

The power display console 18 provides a status of the power center 10. The power display console 18 includes a light emitting diode (LED) display 30 and LEDs 31. The light emitting diode display 30 and LEDs 31 may for example display to a user the following values of the electronic power source 22 including input voltage level, the input current level, a power input to the power center 10, a power output to the power center 10, and/or an indication if a power spike or voltage spike has occurred. The first body 16 provides protection and support for the power conditioning unit 14 and the second body 20 provides protection and support for the power display console 18. The first body 16 and the second body 20 are preferably made from a flexible, medium durability and strength material, for example, polyvinyl chloride (PVC) plastic, polypropylene (PP) plastic, polyethylene therephthalate (PET) plastic, any plastic like material, fiberglass, a malleable metal (e.g., aluminum or steel), or a composite material. The first body 16 and the second body 20 may have length and a width in a range of approximately 0.5 inch to approximately 15 inches, with the preferred range approximately 1 inch to approximately 12 inches. In addition, the power display console 18 includes at least one port that is adapted to electrically cooperate while being distal with said power conditioning unit 14 that includes at least one port. The electrical cooperation may be a wired or wireless means that the at least one port of the power display console 18 may transmit a signal to the power conditioning unit 14.

Referring to FIGS. 1A and 1B, a cross-sectional view along the line 1A-1A and a cross-sectional view along line 1B-1B are shown for the power center according to the first embodiment of the present invention. Specifically, FIG. 1A showing the 1A-1A cross-sectional view depicts a second connecting means 24 of the power display console 18. In particular, FIG. 1B showing the 1B-1B cross-sectional view depicts a first connecting means 26 of the power conditioning unit 14. The first connecting means 26 is located on the first body 16. The first connecting means 26 is made to removably attach with the second connecting means 24. As shown in FIGS. 1A and 1B, the first connecting means 26 are at least one first attaching feature and the second connecting means 24 are at least one first receiving feature. The at least one first attaching feature may have length and a width in a range of approximately 0.001 inch to approximately 0.25 inch, with the preferred range approximately 0.005 inch to approximately 0.20 inch. The at least one first receiving feature may have a length and a width in a range of approximately 0.005 inch to approximately 0.25 inch, with the preferred range approximately 0.001 inch to approximately 0.10 inch. Further., as shown in FIGS. 1A and 1B, the first attaching features from the first body 16 are designed to attach and reattach with the first receiving features in the second body 20.

In the alternative, a first connecting means may be at least one first attaching feature selected from a group consisting of a peg, a stud, a hook, a screw, a bolt, a cable, and a fastener, and said second connecting means may comprise at least one first receiving feature is selected from a group consisting of a slot, a hole, and an opening. In yet another alternative of the present invention, a first connecting means may be at least one second receiving feature selected from a group consisting of a slot, a hole, and an opening, and a second connecting means may be at least one second attaching feature selected from a group consisting of a stud, a hook, a screw, a bolt, a cable, and a fastener. The fastener may be constructed from Velcro®. Further, the choice of at least one first receiving feature, at least one first attaching feature, at least one second attaching feature, and/or at least one second receiving feature or the locations of these features on the power conditioning unit or the power display console are only meant to be exemplary in nature

FIG. 1C shows a perspective view of the power center according to a first embodiment of the present invention, showing the mechanical cooperation of the first connecting means of the power conditioning unit and a second connecting means of the power display console and optional electronic connections between the power display console and the power conditioning unit. As shown in FIG. 1C, the at least one first attaching features 26 are inserted into an mouth 28 of the at least one first receiving feature 24 and slid into a temporary locking portion 30 of the at least one first receiving feature 24 until the at least one first attaching features 26 are firmly securely positioned within the temporary locking portion 30 of the at least one first receiving feature 24. To de-attach the power conditioning unit 14 from the power display console 18, the at least one first attaching feature 26 are slid from the temporary locking portion 30 toward the mouth 28 of the first receiving features and the first attaching feature 26 is removed.

One benefit of this is attachment and de-attachment method is that the power display console 18 may be moved to a location that is suitable for monitoring such as near or in view of a user's seating location while the power conditioning unit 14 may be located near an electronic component. For instance, the power conditioning unit 14 may be attached to an electronic component and hidden from a user's view while the power display console 18 may located in view of a user. As such, a user will have easier viewing access of the power display console 18 and can change controls on the power conditioning unit 14. Preferably, the power conditioning unit 14 will be located behind an electronic component such as an home theater entertainment center or a plasma television while the power display console 18 may be located in plain view. As such, the power display console 18 may be easily viewed by a user seated away from a home theater entertainment center or a plasma television. Further, the shape, the insertion portion, or the temporary locking portion of at least one first receiving feature and/or at least one first attaching features or the locations of these features on the power conditioning unit or the power display console are only meant to be to exemplary in nature.

FIG. 1D shows a cross-sectional view taken along the line 1A-1A and the line 1B-1B of the power center according to a second embodiment of the present invention showing a first electronic port 40, a second electronic port 42, a cavity 36, and electrical connection of the first electronic port 40 and the second electronic port 42. As shown in FIG. 1D, the first body 16 comprises a first electrical port 40 and the second body 20 comprises a second electrical port 42. The first electrical port 40 and the second electrical port 42 are electrically connected by an electronic cable 38. The electronic cable 38 is generally any electrically conductive wire such as a telephone cord. The electronic cable 38 may have a length in the range of approximately 1 foot cable to approximately 50 feet cable with the preferred length range of 5 feet to 25 feet. The electronic cable 38 may generally be any cable that supports the transfer of electronic signals from the power display console 18 to the power conditioning unit. The electronic cable function is to maintain electrical connection between the power conditioning unit 14 and the power display console 18. As such, the power display console 18 is adapted to electrically cooperate with said power conditioning unit 14 while being attached or de-attached.

Optionally, the unused portion of an electronic cable 38 may be coiled by a user and stored within a cavity 36 defined by the second body 20. The cavity may be used for example to hold and or hide any unused electronic cable length. The cavity preferably will be large enough to hold within the range approximately 2 feet to approximately 30 feet of electronic cable. The cavity dimensions are preferably within a width in the range of 2 inches to 10 inches and a length in the range of 2 inches to 10 inches. In the alternative, a cavity 36 may be defined by the first body. The cavity 36 is located in the second body 20 in a location that is remote from a user's field of view. In the alternative, the cavity 36 may be defined by the first body 16. Further, the shape, the location of, the insertion point, for a cavity, an electronic port and an electronic cable on the power conditioning unit or the power display console are only meant to be exemplary in nature.

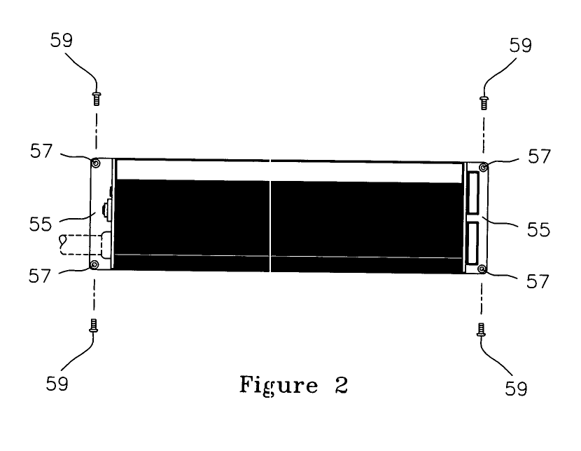

FIG. 2 shows a front view of the power center according to a third embodiment of the present invention showing the power conditioning unit 14 first mounting means 55 to another surface. As further shown in FIG. 2, the first mounting means 55 are two flanges protruding from the power conditioner unit 14 including holes 57. The holes 57 are used for mounting the power conditioning unit 14 to another surface such as a wall, a rack, a back of an entertainment cabinet, a television, or plasma television. In this third embodiment, four screws 59 mount the two flanges to another surface. In this embodiment, the number, the type, and the location of the first mounting means 55 are only exemplary in nature.

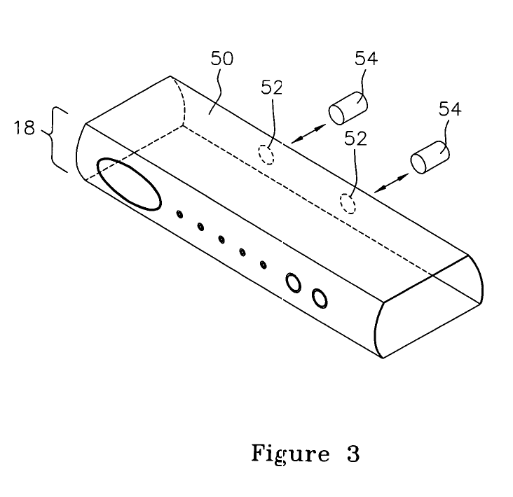

FIG. 3 shows a backside view of the power center according to a fourth embodiment of the present invention showing the power display console 18 second mounting means 52 to another surface. As further shown in FIG. 3, the second mounting means 52 attaches the power display console 18 to a horizontal, a vertical, or an inclined surface. As shown for example in FIG. 3, the second mounting means 52 comprises holes built into the back surface 50 of the power display console 18. The second mounting means 52 are substantially elliptical cutouts that insert into and connect with adjoining protruding receiving features 54 that are tabs. The second mounting means 52 length and width are preferably within the range of approximately 0.10 inch to approximately 5.0 inches, with the more preferred range of approximately 0.10 inch to approximately 1.5 inches. In another alternative of the present invention, a second mounting means may be selected from a group consisting of a slot, a hole, and an opening. In another alternative of the present invention, a second mounting means may be selected from a group consisting of a stud, a hook, a screw, a bolt, a cable, and a fastener. The fastener may be Velcro®. The number, the type, and the location of the second mounting means is only exemplary in nature.

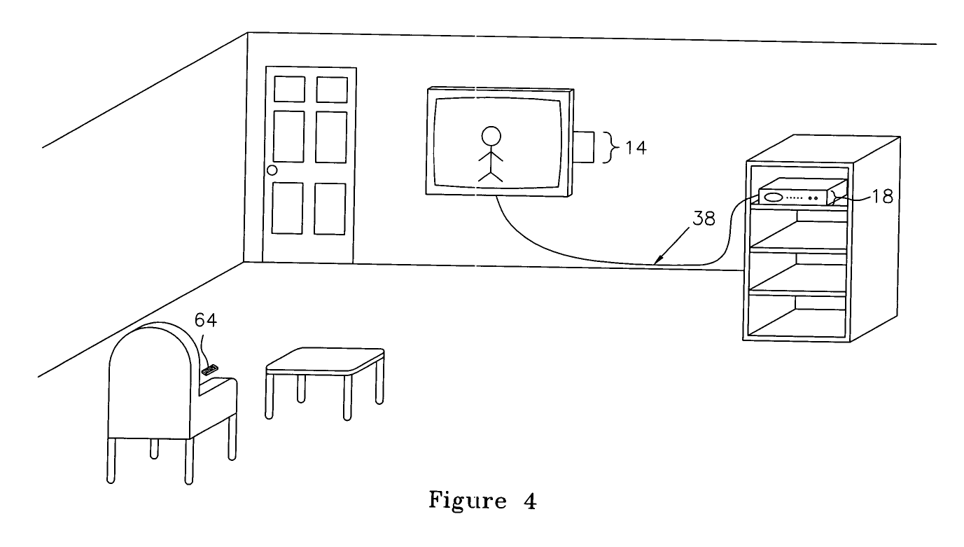

FIG. 4 is a front view of the power center according to a fifth embodiment of the present invention, showing a first wireless link for controlling the power conditioning unit and the power display console. In this embodiment, the first wireless link comprises a transceiver unit (not shown) within the power conditioning unit 14, and a remote control unit 64. In this example, the remote control unit 64 will send and receive wireless signals to the transceiver unit (not shown). In this example, the transceiver unit and the remote control unit 64 comprise the first wireless link to exchange and to update information between the power display console 18 and a remote control unit 64, wherein said first wireless link to exchange and to update information is selected from a group consisting of: infrared (IR), radio frequency (RF), and optical. In the alternative, the power conditioning unit 14 and the power display console 18 may be remotely controlled wirelessly by a user. Optionally, the power conditioning unit 14 and the power display console 18 may comprise a second wireless link to exchange and to update information selected from a group consisting of infrared (IR), radio frequency (RF), and optical. The type, location, or position of the remote control unit 64 is only exemplary in nature.

Information as herein shown and described in detail is fully capable of attaining the above-described object of the invention, the present preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, one skilled in the art should recognize that various changes and modifications in form and material details may be made without departing from the spirit and scope of the inventiveness as set forth in the appended claims. No claim herein is to be construed under the provisions of 35 U.S.C. § 112, sixth paragraph, unless the element is expressly recited using the phrase “means for.”

1-20. (canceled)

21. A power center connectable to a source of electrical power comprising:
a power conditioning unit in a first body for conditioning power received from a power source; and
a power display console in a second body for providing an indication of the state of said power conditioning unit; and
wherein said first body is mechanically attachable to said second body; and
wherein said power display console is adapted to electrically cooperate with said power conditioning unit.

22. A power center in accordance with claim 1, wherein said power display console is adapted to electrically cooperate with said power conditioning unit while being attached and detached.

23. A power center in accordance with claim 22, wherein said first body includes at least one first attaching feature selected from a group consisting of a stud, a hook, a screw, a bolt, a cable, a fastener, and a Velcro® strap and said second body includes at least one first receiving feature is selected from a group consisting of a slot, a hole, and an opening on said second body.

24. A power center in accordance with claim 22, wherein said electrical cooperation adaption includes at least one wire connecting said first body and said second body.

25. A power center in accordance with claim 21, wherein said first body further comprises a first mounting for attaching said first body to a surface selected from a group consisting of a horizontal surface, a vertical surface, or an inclined surface.

26. A power center in accordance with claim 21, wherein said second body further comprises a second mounting for attaching the power display console to a surface selected from a group consisting of a horizontal surface, a vertical surface, or an inclined surface.

27. A power center in accordance with claim 22, wherein said electrical cooperation adaption includes at least one wireless connection connecting said first body and said second body.

28. A power center in accordance with claim 27, wherein said wireless connection is selected from a group consisting of infrared (IR), radio frequency (RF), and optical.

29. A power center in accordance with claim 27, further comprising a second wireless link to exchange and to update information to said power display counsel, wherein said second wireless link to exchange and to update information is selected from a group consisting of infrared (IR), radio frequency (RF), and optical.

30. A power center in accordance with claim 21, wherein said first body and said second body are made from a material selected from the group consisting of polyvinyl chloride (PVC) plastic, polypropylene (PP) plastic, polyethylene therephthalate (PET) plastic, any plastic like material, fiberglass, a malleable metal, and a composite material.

31. A power center in accordance with claim 24, further comprising a cavity for receiving said wire in at least one of a group consisting of said first body and said second body.

32. A power center in accordance with claim 26, wherein said first body includes at least one power outlet and said wireless link allows control of at least one attribute of the power to said power outlet.

33. A power center in accordance with claim 32, wherein said first body further includes at least one second outlet always connected to said source of electrical power.

34. A power center in accordance with claim 27, further comprising a remote control unit for controlling the operation of said power conditioning unit and said power display counsel.

35. A power center in accordance with claim 33, wherein said remote control unit is locatable at a position remote from either of said power conditioning unit and said power display counsel.

36. A remote controlled power center attachable to a source of electrical power comprising:
a power conditioning unit having at least one electrical outlet that is always directly connected to said source of electrical power and at least one other power outlet switchably connected to said source of electrical power and an electrical circuit for conditioning the electrical power supplied to at least said one other power outlet; and
a power display unit attachable to said power conditioning unit for displaying the state of the power supplied to at least the one other power outlet; and
a connection between said power conditioning unit and said power display unit for transferring information between said power conditioning unit and said power display unit.

37. A remote controlled power center according to claim 36, wherein said connection is by at least one wireless link.

38. A remote controlled power center according to claim 36, further comprising a remote control for communicating with said power conditioning unit and said power display unit.

39. A remote controlled power center according to claim 37, further comprising a remote control for communicating with said power conditioning unit and said power display unit and a second wireless link for communicating with said power conditioning unit and said power display unit.

40. A remote controlled power center according to claim 38, wherein said power conditioning unit and said power display unit are adapted for both mounting together and for mounting at separate locations.

41. A remote controlled power center according to claim 39, wherein said power conditioning unit and said power display unit are adapted for both mounting together and for mounting at separate locations.
